(19) United States
(12) Patent Application Publication
(10) Pub. No.: US 2025/0183566 A1
(43) Pub. Date: Jun. 5, 2025

(54) PLUG-IN CONNECTOR COMPRISING A MODULAR CONTACT DEVICE

(71) Applicant: PHOENIX CONTACT GMBH & CO. KG, Blomberg (DE)

(72) Inventors: Jochen Mestars, Blomberg (DE); Michael Blauth, Detmold (DE)

(21) Appl. No.: 18/842,404

(22) PCT Filed: Mar. 2, 2023
(86) PCT No.: PCT/EP2023/055253

§ 371 Date: Aug. 29, 2024

(30) Foreign Application Priority Data
Mar. 4, 2022 (BE) BE2022/5151

(51) Int. Cl. H01R 11/05; H01R 4/58; H01R 13/11

(52) U.S. Cl. CPC H01R 11/05; H01R 4/58; H01R 13/112

(57) ABSTRACT

A plug-in connector includes: at least one contact device for transmitting electrical energy and/or electrical signals, the at least one contact device including at least one first connection element having a coupling portion and at least one second connection element having a coupling portion. The at least one first connection element and the at least one second connection element each are formed as individual parts. The coupling portions contact one another to form the at least one contact device.

### CROSS-REFERENCE TO PRIOR APPLICATIONS

This application is a U.S. National Phase application under 35 U.S.C. § 371 of International Application No. PCT/EP2023/055253, filed on Mar. 2, 2023, and claims benefit to Belgian Patent Application No. BE 2022/5151, filed on Mar. 4, 2022. The International Application was published in German on Sep. 7, 2023 as WO/2023/166104 under PCT Article 21(2).

### FIELD

The present invention is in the field of electromechanics and relates to a plug-in connector comprising at least one contact device for transmitting electrical energy and/or electrical signals.

### BACKGROUND

Plug-in connectors for connecting electrical conductors, which are used, for example, in the field of electrical installation technology for buildings and industrial plants or, for example, in printed circuit boards, usually have integrally formed (one-piece), electrically conductive contact devices made of a metal material, wherein a conductor connection region of the contact device is often connected to a contact socket of the contact device in a material-locking manner and without any separation point.

Furthermore, plug-in connectors are known in which the conductor connection region and the contact socket of such an electrically conductive contact device are formed from two distinct and thus separate metal materials, which are permanently connected to one another by means of welding or clinching. In this case, the connection must be made before the contact devices are installed in the housing of the connector, whereby the contact devices are integrated into the housing in an already joined state.

For example, an integrally formed electrical contact part comprising a contact spring arrangement and comprising a connection means in the form of a contact fork for connecting an electrical assembly, for example an electrical circuit board, is known from the German utility model no. DE 20 2010 010 275 U1. The contact part is simply manufactured in one-piece from sheet metal as a punched and bent part. The contact spring arrangement is used to connect an adjacent contact part and comprises two symmetrically designed and arranged

contact spring legs as well as fork portions arranged opposite the contact spring legs for connection, i.e., for receiving contact spring legs of the adjacent contact part to form a plug-in connection. There is a cross brace on the fork portions, whereby the fork portions and the cross brace form a substantially U-shaped insertion region. Furthermore, the contact fork of the connecting means is formed with two contact forks on the cross brace and rotated 90° with respect to the contact spring arrangement.

Furthermore, a plug-in connector comprising spring contact elements having oppositely arranged spring contact strips for receiving and holding a circuit board is known, for example, from U.S. Pat. No. 4,322,120. Corresponding tongues for contacting are located at the free ends of the spring contact strips. Additional spring elements are arranged on each spring contact strip, which elements form a clamp for contacting a plug-in pin of an adjacent spring contact element in order to realize a series of spring contact elements by forming plug-in connections. In addition, each contact element has a connection pin. Each contact element is produced from a single punched part.

In the case of plug-in connectors comprising complex contact devices, for example having different material thicknesses in the conductor connection region and in the region of the contact socket, not only the production but above all the installation of the contact device can be very complicated and time-consuming.

### SUMMARY

In an embodiment, the present invention provides a plug-in connector, comprising: at least one contact device configured to transmit electrical energy and/or electrical signals, the at least one contact device including at least one first connection element comprising a coupling portion and at least one second connection element comprising a coupling portion, wherein the at least one first connection element and the at least one second connection element each comprise individual parts, and wherein the coupling portions are configured to contact one another to form the at least one contact device.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a perspective view of a contact device of an exemplary embodiment of the plug-in connector according to the present invention in a first state;

FIG. 2 is a perspective view of the contact device from FIG. 1 in a second state;

FIG. 3 is a perspective view of an arrangement of first connection elements of contact devices of an exemplary embodiment of the plug-in connector according to the present invention;

FIG. 4 is a perspective view of an arrangement of contact devices of an exemplary embodiment of the plug-in connector according to the present invention;

FIG. 5 is a perspective view of a first housing part of an exemplary embodiment of the plug-in connector according to the present invention;

FIG. 6 is a perspective view of the first housing part from FIG. 5 with first connection elements of contact devices of an exemplary embodiment of the plug-in connector according to the present invention arranged therein;

FIG. 7 is a front view of the first housing part from FIG. 6 with first connection elements of contact devices of an exemplary embodiment of the plug-in connector according to the present invention arranged therein;

FIG. 8A is a perspective view of a second housing part of an exemplary embodiment of the plug-in connector according to the present invention;

FIG. 8B is a further perspective view of the second housing part from FIG. 8A;

FIG. 8C is a side view of the second housing part from FIGS. 8A and 8B;

FIG. 9A is a perspective view of an arrangement of the first housing part from FIGS. 5 to 7 and the second housing part from FIG. 8A to 8C for forming an exemplary embodiment of the plug-in connector according to the present invention in a first state;

FIG. 9B is a perspective view of the arrangement with the housing parts from FIG. 9A for forming an exemplary embodiment of the plug-in connector according to the present invention in a second state;

FIG. 10A is a front view of the plug-in connector from FIG. 9A;

FIG. 10B is a partial sectional view of the plug-in connector from FIG. 10A (section A-A in FIG. 10A).

### DETAILED DESCRIPTION

In an embodiment, the present invention provides an improved plug-in connector in which at least one contact device for transmitting electrical energy and/or electrical signals is optimized, in particular with regard to manufacturing, installation and electrical conductivity.

In an embodiment, the present invention provides a plug-in connector comprising at least one contact device for transmitting electrical energy and/or electrical signals, wherein the at least one contact device has at least one first connection element comprising a coupling portion and at least one second connection element comprising a coupling portion. The connection elements are designed as (separate) individual parts and are configured to contact one another to form at least one contact device.

According to a first general aspect, the present invention relates to a plug-in connector, preferably a plug-in connector for connecting at least one electrical conductor, a mating connector and/or a base strip, particularly preferably a circuit board, the plug-in connector comprising at least one contact device for transmitting electrical energy and/or electrical signals, wherein the at least one contact device has at least one first connection element comprising a coupling portion and at least one second connection element comprising a coupling portion, wherein the at least one first connection element and the at least one second connection element are in the form of individual parts and the coupling portions are designed and/or arranged to contact one another, preferably to contact one another substantially variably in a plug-in direction and/or preferably in the assembled state of the plug-in connector, in order to form the at least one contact device.

The plug-in connector according to the present invention is preferably characterized by at least one modular and/or flexibly configurable contact device for transmitting electrical energy and/or electrical signals. By designing connection elements as individual parts and thus as separate parts, it is possible to use comparatively small connection elements and/or connection elements that are easy to produce. A certain modularity of the connection elements as individual parts makes it possible to achieve, for example, different material properties (substance properties) and/or different geometric configurations, which, for example, cannot be realized with known contact devices as a single part or only with excessive manufacturing effort.

According to the present invention, the connector is characterized primarily by one or more multi-part contact devices and thus by a certain design flexibility and also simplified assembly.

According to a further aspect of the present invention, it can be provided that the coupling portion of the at least one first connection element and the coupling portion of the at least one second connection element are configured to form with each other, at least in portions, substantially a positive connection and/or, at least in portions, substantially a non-positive connection.

It is possible that the coupling portion of the at least one first connection element and the coupling portion of the at least one second connection element are configured to form a plug-in connection and/or a latching connection and/or a press connection.

The connections disclosed herein ensure, above all, both a mechanically stable and an electrically reliable connection between individual connection elements of the at least one contact device.

According to a further aspect of the present invention, it can be provided that the at least one first connection element and/or the at least one second connection element are each produced from a sheet, preferably from a substantially flat sheet or thin sheet, wherein the sheet of the at least one first connection element has a first sheet thickness, and the sheet of the at least one second connection element has a second sheet thickness, wherein the first sheet thickness and the second sheet thickness can be substantially the same or different. It is also possible for the at least one first connection element and/or the at least one second connection element to be produced from a solid metallic material, preferably a round material, by means of at least one machining process, for example at least one turning process and/or at least one milling process.

Alternatively or additionally, it is possible for the at least one first and/or the at least one second connection element to be designed to be spring-elastic at least in portions. This can, for example, compensate for any manufacturing tolerance or a tolerance that occurs during installation. Furthermore, contacting of the at least one first connection element with the at least one second connection element via the coupling portions can be improved.

According to a further aspect of the present invention, it can be provided that the at least one first connection element and the at least one second connection element have a different stiffness and/or a different electrical conductivity and/or a different relaxation constant. The stiffness can, for example, be understood in geometric terms, preferably in the form of different material thicknesses. It is also possible that stiffness can be understood as the strength of the material and thus as a characteristic value in relation to the stress caused by mechanical loads.

In other words, the respective connection elements can be designed as individual parts to meet their requirements and/or be individually configured.

It is possible for the at least one first connection element to have a receiving portion for connecting a component, wherein the coupling portion is arranged at a first free end of the at least one first connection element and the receiving portion is arranged at a second free end of the at least one first connection element, and the at least one first connection element between the coupling portion and the receiving portion is substantially in the form of a flat strip, preferably substantially in the form of a flat strip that is angled in portions.

According to a further aspect of the present invention, it can be provided that the receiving portion has two clamping legs that are spaced apart from one another and/or arranged opposite one another and are preferably designed to be substantially symmetrical and/or substantially fork-shaped with respect to a plane in order to clampingly connect and/or contact the component. The component can be an electrical and/or an electronic component. The component can be, for example, a circuit board or a plug-in connector.

It is possible that the at least one second connection element is substantially U-shaped and/or substantially bow-shaped and has two coupling portions that are substantially identical to one another and/or are spaced apart from one another and/or are arranged opposite one another.

According to a further aspect of the present invention, it can be provided that at least one coupling portion is substantially flat and/or substantially plate-shaped. As a result, for example, a plug-in connection and/or a press connection can be realized in a relatively simple manner with a complementarily designed coupling portion of the at least one first connection element.

According to a further aspect of the present invention, it can be provided that the plug-in connector has at least one second contact device comprising at least one first connection element and at least one second connection element, wherein the at least one first connection element of the at least one first contact device and the at least one first connection element of the at least one second contact device are substantially identical to one another at least in portions, and/or wherein the at least one second connection element of the at least one first contact device and the at least one second connection element of the at least one second contact device are substantially identical to one another. The at least one second contact device can have a coupling portion and/or a receiving portion as disclosed herein in connection with the at least one first contact device.

It is possible that the at least one first connection element and/or the at least one second connection element is produced at least in portions by means of at least one punching process and/or at least one bending process, and/or is in each case formed integrally in one piece. As a result, the at least one first connection element and/or the at least one second connection element can, for example, be individually and optimally adapted to the geometric conditions.

According to a further aspect of the present invention, it can be provided that the plug-in connector has a first housing part and a second housing part for forming a plug-in connection substantially in a plug-in direction, wherein the at least one first connection element is arranged and/or fastened in the first housing part and the at least one second connection element is arranged and/or fastened in the second housing part.

This makes it possible, for example, for the at least one contact device to be formed during installation of the first housing part with the second housing part by contacting the at least one first connection element with the at least one second connection element.

According to a further aspect of the present invention, it can be provided that the at least one first connection element is arranged and/or fastened in the first housing part and the at least one second connection element is arranged and/or fastened in the second housing part such that the at least one contact device is formed when the plug-in connection is formed, preferably by forming a plug-in connection of the coupling portion of the at least one first connection element with the coupling portion of the at least one second connection element substantially in a plug-in direction.

The first housing part and the second housing part are preferably separate, i.e., two housing parts produced separately from each other.

Identical or functionally equivalent components or elements are denoted by the same reference signs in figures. For the explanation thereof, reference is also made in part to the description of other exemplary embodiments and/or figures in order to avoid repetitions.

The following detailed description of the exemplary embodiments illustrated in the figures serves for more detailed illustration or clarification and is not intended to limit the scope of the present invention in any way.

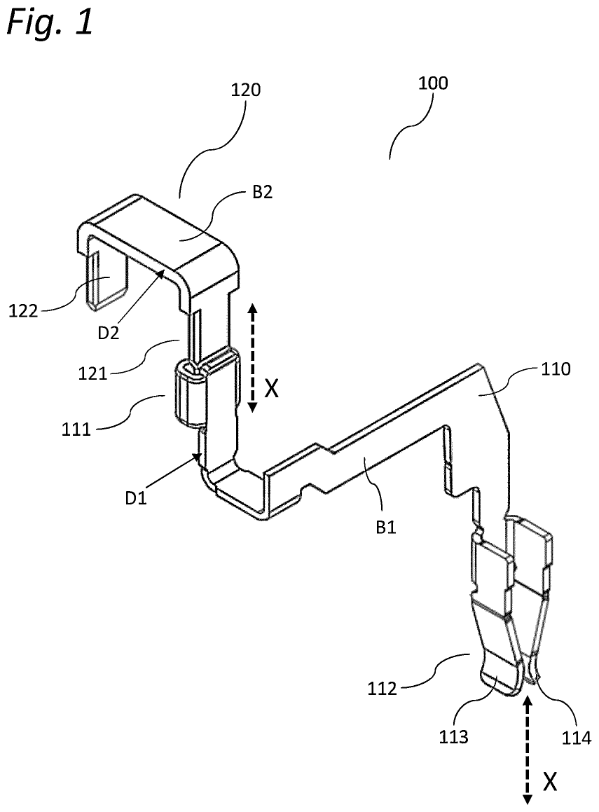

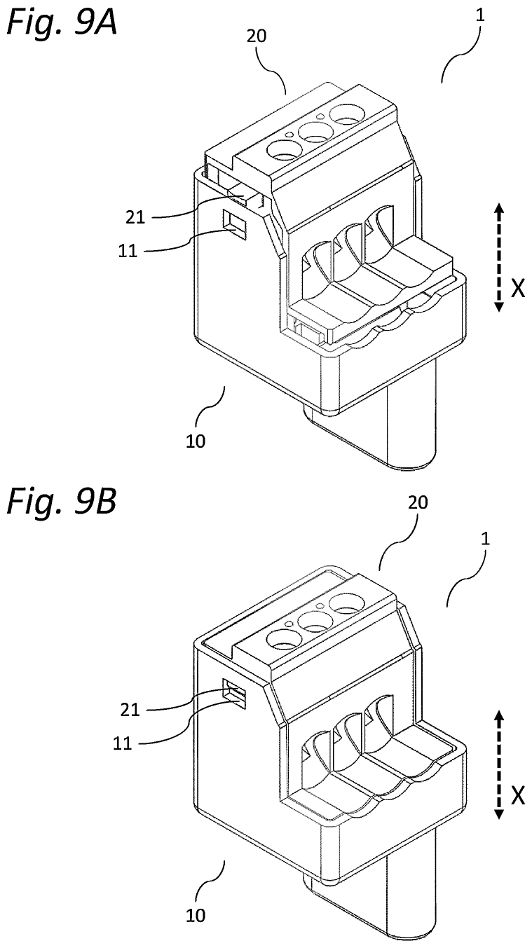

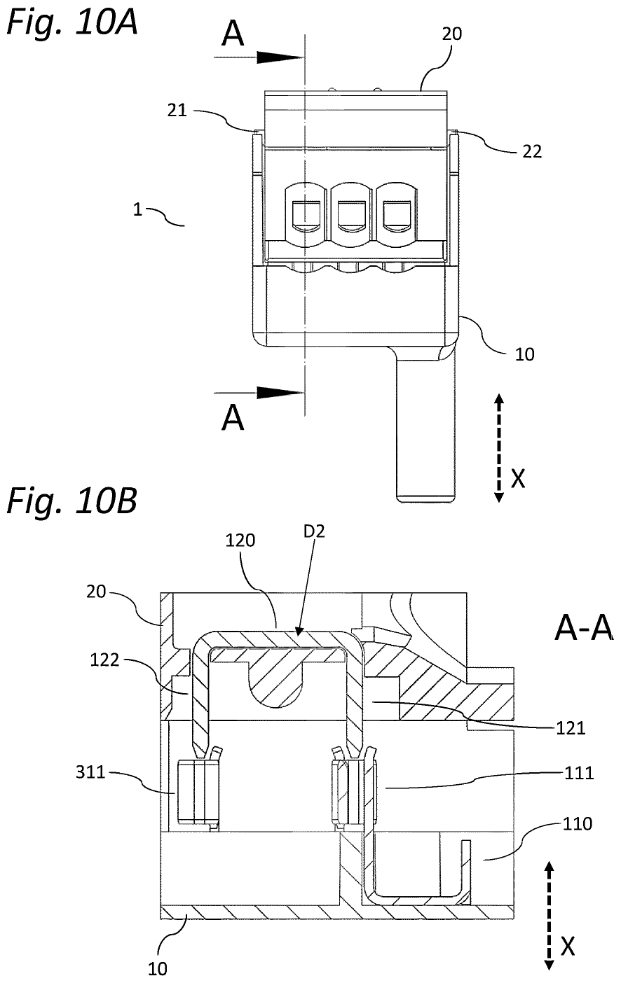

FIG. 1 is a perspective view of a first contact device 100 of an exemplary embodiment of a plug-in connector 1 (see FIG. 9A to 10B) according to the present invention in a first state. The first contact device 100 is configured and/or designed for integration, i.e., installation, in the plug-in connector 1, and serves to transmit electrical energy and/or electrical signals. The plug-in connector 1 is preferably configured and/or designed as a plug-in connector on the one hand for connecting electrical conductors and on the other hand for connecting a component. The component and the electrical conductors are not shown in the figures for reasons of clarity. The component is preferably an electrical and/or electronic component, for example a circuit board. The plug-in connector 1 and other components and elements of the plug-in connector 1 will be described in more detail with reference to further figures.

The first contact device 100 has at least one first connection element 110 and at least one second connection element 120. Rather, the first contact device 100 is formed by at least one first connection element 110 and by at least one second connection element 120. For the sake of simplicity, the term “at least” is omitted below where appropriate. It is possible for the first contact device 100 to have exactly one first connection element 110 and exactly one second connection element 120 and thus a total of only two connection elements 110 and 120. Alternatively, it is possible for the first contact device 100 to have more than two connection elements 110 and 120, which as individual parts form the first contact device 100 of the plug-in connector 1.

Both the first connection element 110 and the second connection element 120 are designed as individual parts and thus as separate elements. This ensures, for example, a modularity of the structure of the first contact device 100 and thus also a flexibility of the configuration, production and installation of the first contact device 100, by which the plug-in connector 1 according to the present invention is characterized. Above all, extensive and complex production processes can be reduced or avoided, as will be explained in more detail in the following description.

The first connection element 110 is integrally produced in one piece from a first sheet B1, at least in portions, by means of at least one bending process and/or at least one punching process. Analogous to the first connection element 110, the second connection element 120 is integrally produced in one piece from a second sheet B2, at least in portions, by means of at least one bending process and/or at least one punching process. Preferably, the first sheet B1 and/or the second sheet B2 can be a thin sheet and thus a sheet having a sheet thickness of preferably less than 3 mm. The first sheet B1 is characterized by a first sheet thickness D1 and the second sheet B2 is characterized by a second sheet thickness D2, wherein the first sheet thickness D1 can be different from the second sheet thickness D2. The material, i.e., the substance of the first sheet B1, can be different from the material, i.e., the substance of the second sheet B2. The material of the first sheet B1 and/or the material of the second sheet B2 can preferably be based on copper and/or a copper alloy. Alternatively, it is possible for the first connection element 110 and/or the second connection element 120 to be produced from a solid metal material by means of at least one machining process, for example a turning process.

The first contact device 100 shown in FIG. 1 is in a first state in which the first contact device 100 is not yet formed by the connection elements 110 and 120. In other words, the first connection element 110 and the second connection element 120 do not yet contact each other in order to be able to transmit electrical energy and/or electrical signals.

The first connection element 110 comprises a coupling portion 111 and a receiving portion 112. The second connection element 120 comprises two coupling portions 121 and 122. The coupling portion 111 of the first connection element 110 is arranged and/or formed at a first free end of the first connection element 110, and the receiving portion 112 is arranged and/or formed at a second free end of the first connection element 110. Between the coupling portion 111 and the receiving portion 112, the first connection element 110 is angled and/or flat-band-shaped in portions. As can be seen from FIG. 1, the first connection element 110 between the coupling portion 111 and the receiving portion 112 is rectangular in portions and extends in different spatial directions.

The receiving portion 112 is configured and/or formed for connecting a component as disclosed herein. The component can also be, for example, a mating connector or a base strip. The receiving portion 112 has a first clamping leg 113 and a second clamping leg 114. The first clamping leg 113 and the second clamping leg 114 serve as spring-elastic elements for connecting the component in a clamping manner, i.e., for detachably connecting the first connection element 110 to the component for transmitting electrical energy and/or electrical signals. The first clamping leg 113 and the second clamping leg 114 are bow-shaped or curved in portions and are spaced apart from one another and arranged opposite one another. Preferably, the first clamping leg 113 and the second clamping leg 114 are substantially symmetrical and fork-shaped with respect to a plane in order to connect the component in a clamping manner. In other words, a component that is, for example, substantially plate-shaped and is received between the clamping leg 113 and the clamping leg 114 is connected in a clamping manner by applying a compressive force through the clamping legs 113 and 114. The receiving portion 112 can also be designed as a contact socket for receiving a contact pin. Instead of the clamping legs 113 and 114, the receiving portion 112 can be designed, for example, as a substantially cylindrical clamping bushing.

The coupling portion 111 of the first connection element 110 of the first contact device 100 is designed to be complementary to the coupling portion 121 in order to form a plug-in connection and/or a press connection with the coupling portion 121 of the second connection element 120. Preferably, the coupling portion 111 comprises a flat plug sleeve or is designed as a flat plug sleeve, and is configured and/or dimensioned to receive the coupling portion 121 of the second connection element 120 in a positive and non-positive (clamping) manner substantially in a plug-in direction X in order to connect the first connection element 110 to the second connection element 120 mechanically on the one hand and electrically conductively on the other hand.

As can be seen from FIG. 1, the second connection element 120 is formed substantially symmetrically with respect to a plane. Both the first coupling portion 121 and the second coupling portion 122 are substantially flat and substantially plate-shaped. The second connection element 120 is preferably configured and/or designed to connect at least one electrical conductor. In analogy to the component, the at least one electrical conductor is not shown in the figures for reasons of clarity.

Due to the complementary design of the coupling portion 111 of the first connection element 110 and the coupling portion 121 of the second connection element 120, it is possible to variably contact the two connection elements 110 and 120 with one another in one direction, preferably in the plug-in direction X. In other words, the degree of contacting overlap and thus of the positive connection can be varied by the position of the second connection element 120 relative to the first connection element 110 or is variable or at least compensates for play if both the first connection element 110 and the second connection element 120 are arranged and/or aligned accordingly in a housing or in a housing part 10 and 20 of the plug-in connector 1 (see, for example, FIGS. 9A and 9B).

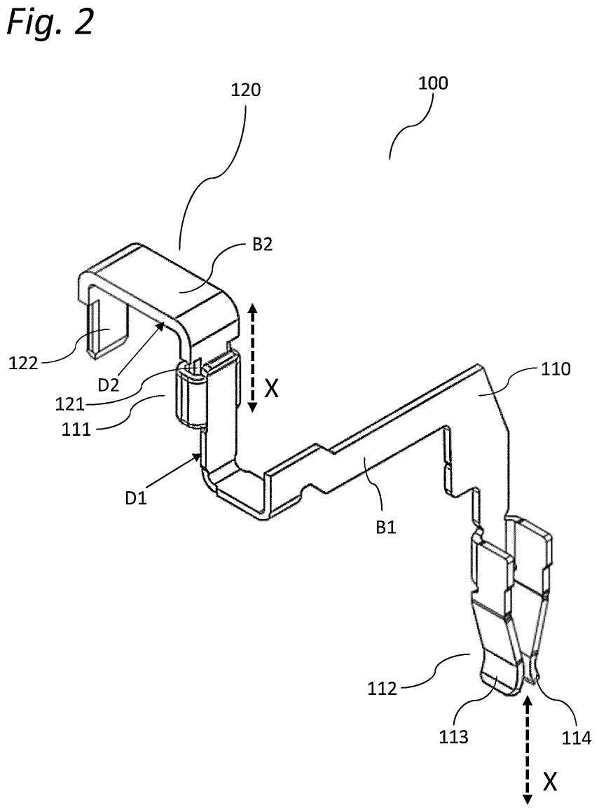

FIG. 2 shows the first contact device 100 from FIG. 1 in a second state, according to which the first contact device 100 is formed by the first connection element 110 and by the second connection element 120 via the coupling portions 111 and 121, which are in contact with one another in portions. In other words, the substantially flat and substantially plate-shaped coupling portion 121 is received in the plug-in direction X in a substantially positive and non-positive manner in the coupling portion 111 designed as a flat plug sleeve, wherein a transmission of electrical energy and/or electrical signals is ensured due to corresponding electrically conductive material properties. As can also be clearly seen from FIG. 2, tolerances resulting from the installation of the first connection element 110 and the second connection element 120 can be compensated for by forming a plug-in connection between the coupling portions 111 and 121, so that this does not lead to any impairment of the properties for transmitting electrical energy and/or electrical signals in the first contact device 100.

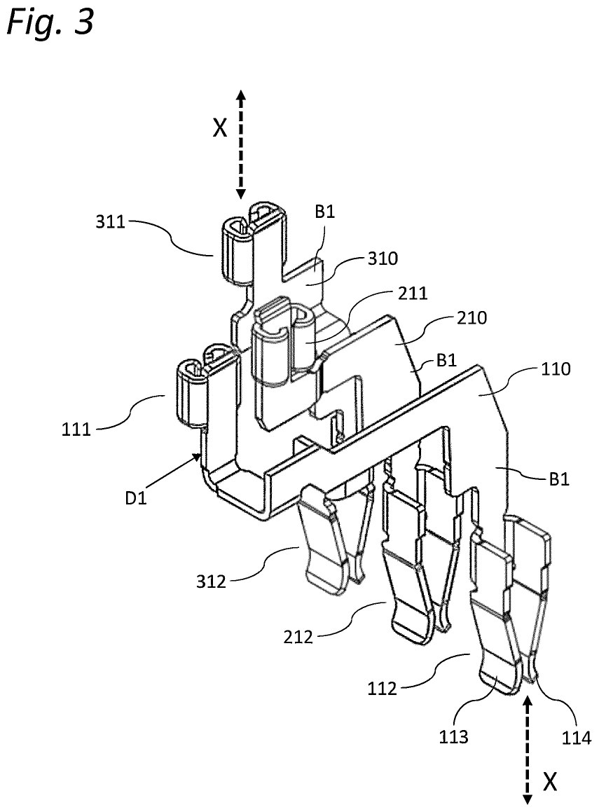

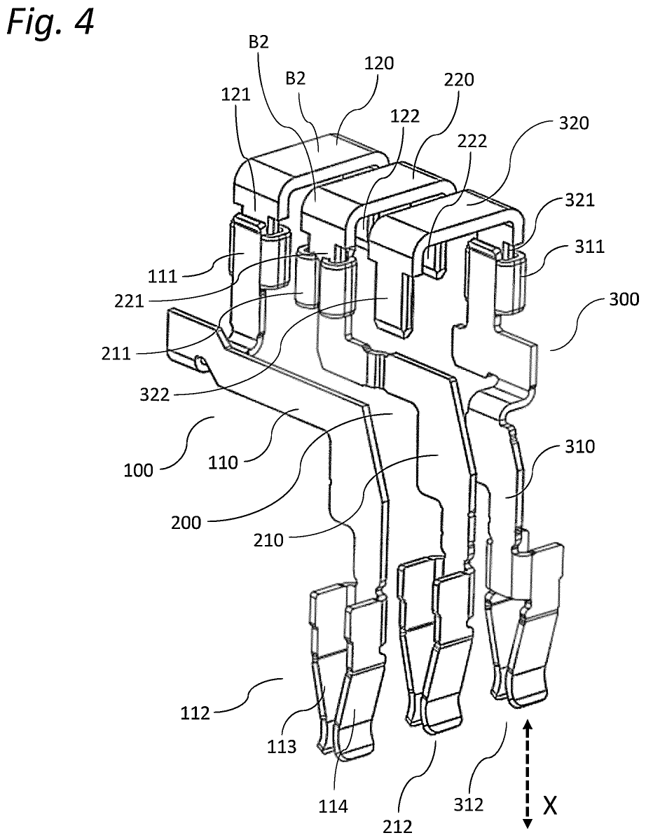

FIG. 3 is a perspective view of an arrangement of first connection elements 110, 210 and 310, as arranged and/or fastened in a housing or in a housing part 10 of a plug-in connector 1 according to the present invention. The first connection element 110 is assigned to a first contact device 100, the first connection element 210 is assigned to a second contact device 200, and the first connection element 310 is assigned to a third contact device 300. It is possible that in a further exemplary embodiment of the plug-in connector 1 according to the present invention more than three contact devices 100, 200 and 300 are used. For reasons of clarity, the second connection elements 120, 220 and 320 of the respective contact devices 100, 200 and 300 are not shown in FIG. 3. However, the second connection elements 120, 220 and 320 are shown together with the respective assigned first connection elements 110, 210 and 310 for forming the respective contact devices 100, 200 and 300 in a further perspective view in FIG. 4.

As can be seen from FIG. 3, the receiving portions 112 of the first connection element 110, 212 of the first connection element 210 and 312 of the first connection element 310 are designed to be substantially identical to one another and each comprise two clamping legs as disclosed herein, of which the clamping legs 113 and 114 of the first connection element 110 of the first contact device 100 are identified in FIG. 3. Furthermore, each coupling portion 111, 211 and 311 of a corresponding first connection element 110, 210 and 310 is designed as a flat plug sleeve or comprises a flat plug sleeve. All of the coupling portions 111, 211 and 311 are designed to form a plug-in connection and a press connection substantially in the plug-in direction X. The coupling portions 111, 211 and 311 are arranged opposite the receiving portions 112, 212 and 312 of the first connection elements 110, 210, 310, i.e., on opposite sides of the corresponding contact device 100, 200 and 300 and offset from one another, i.e., not aligned.

FIG. 4 is a perspective view of the arrangement of the first connection elements 110, 210 and 310 from FIG. 3 and associated or assigned second connection elements 120, 220 and 320 and thus an arrangement of three contact devices 100, 200 and 300 in a second state, which is the formed state with respect to the corresponding contact device 100, 200 and 300.

The second connection elements 120, 220 and 320 are, as can be seen from FIG. 4, preferably designed to be substantially identical to one another. Thus, in the plug-in connector 1 according to the present invention, for example, the use of certain elements as identical parts can be ensured, which at the same time leads to a reduction in the necessary components and elements in the plug-in connector 1.

Due to the design of the first and second connection elements 110, 210, 310 and 120, 220, 320 as (separate) individual parts, the production and installation of, for example, relatively complex contact devices 100, 200, 300 is possible without the need for complex and laborious production methods in the form of corresponding bending processes and/or punching processes. The plug-in connector 1 according to the present invention is thus characterized by at least one contact device 100, 200, 300, which is easy to manufacture and assemble, but has a modular and flexible structure.

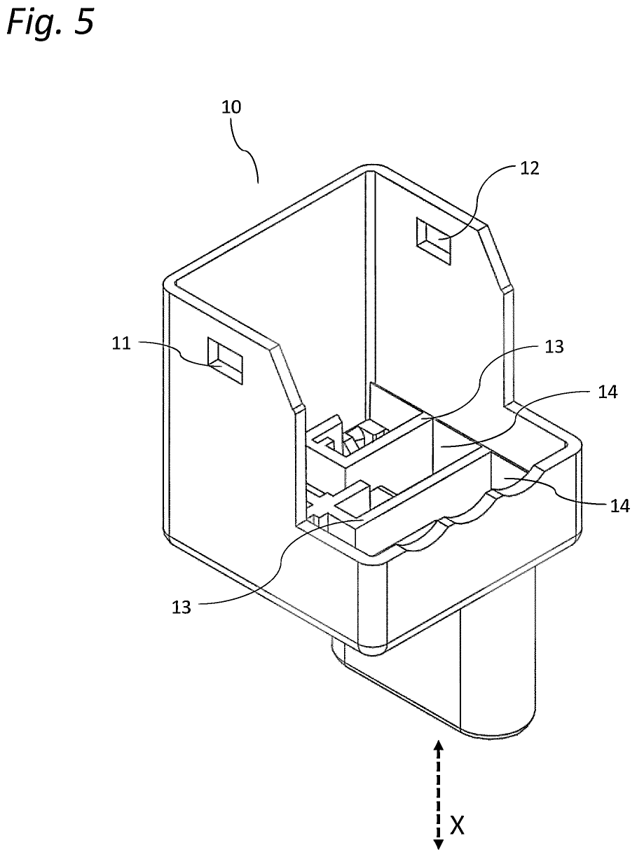

FIG. 5 is a perspective view of a first housing part 10 of an exemplary embodiment of the plug-in connector 1 according to the present invention. The first housing part 10 is preferably made of an insulating material, for example based on plastics material. The first housing part 10 can be produced by means of at least one injection-molding process and/or by means of at least one casting process. Alternatively, it is possible that the first housing part 10 is produced by means of at least one sintering process.

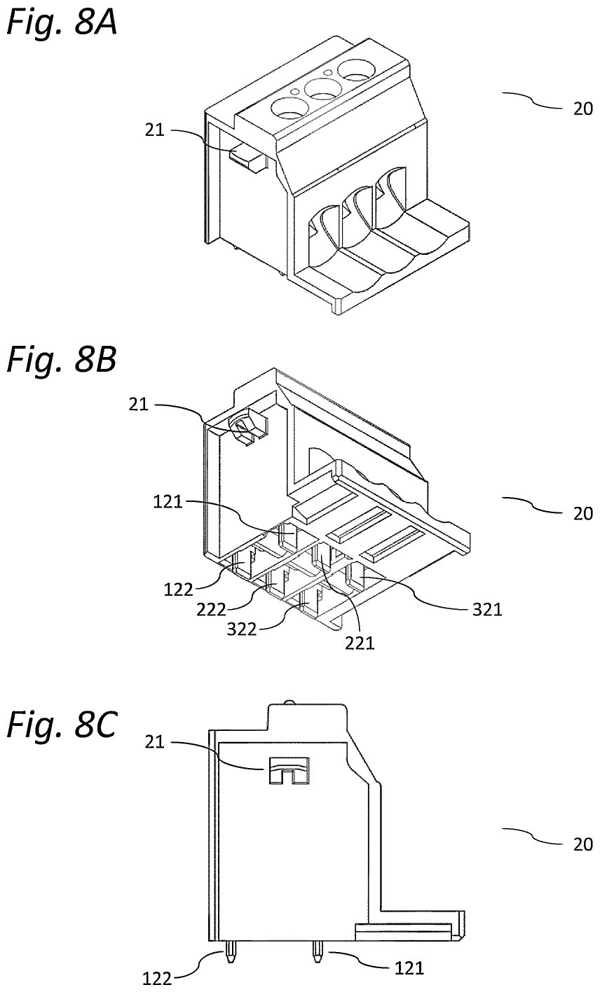

The first housing part 10 has a substantially cuboid housing base body that is open on one side in a plug-in direction X and is designed to receive a second housing part 20 (see, for example, FIG. 8A to 8C) while forming a detachable latching connection, which will be described in more detail below. To form the detachable latching connection, two opposite walls or outer walls (not denoted in greater detail) have a first opening 11 and a second opening 12. Both the first opening 11 and the second opening 12 have a substantially rectangular cross section.

The first housing part 10 has further walls and/or wall portions and/or intermediate walls, of which the intermediate walls 13 are identified in FIG. 5. Between the intermediate walls 13 there are correspondingly formed cavities 14 in which the corresponding contact device 100, 200 and 300 and in this case preferably only the corresponding first connection element 110, 210 and 310 is received and/or fastened.

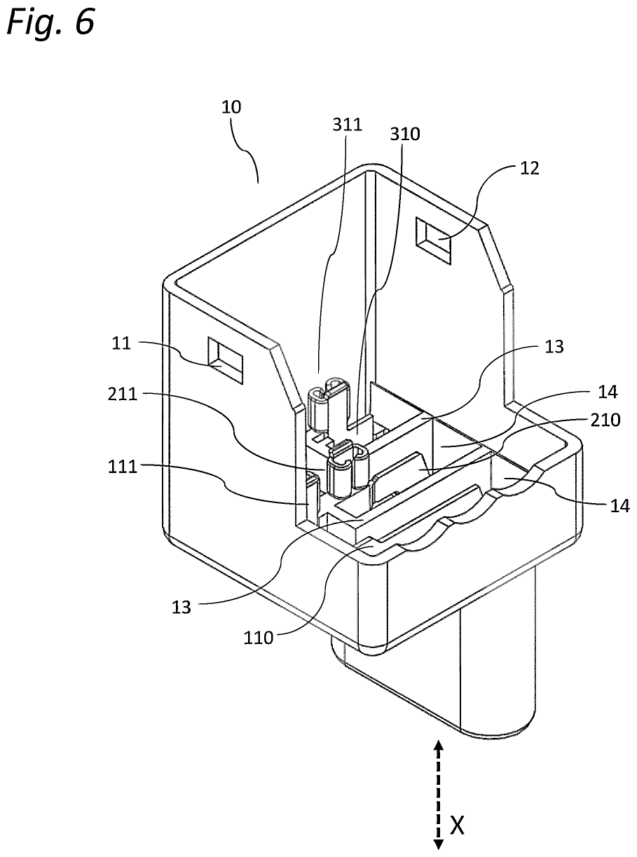

The arrangement and preferably fastening of the first connection elements 110, 210 and 310 in the respective cavities 14 in the first housing part 10 is shown in FIG. 6. As can be seen from FIG. 6, the plug-in direction X is the same for the second housing part 20 to form the housing of the plug-in connector 1 as well as for the corresponding second connection element 120, 220 and 320 to form the corresponding contact device 100, 200 and 300 (see FIG. 4).

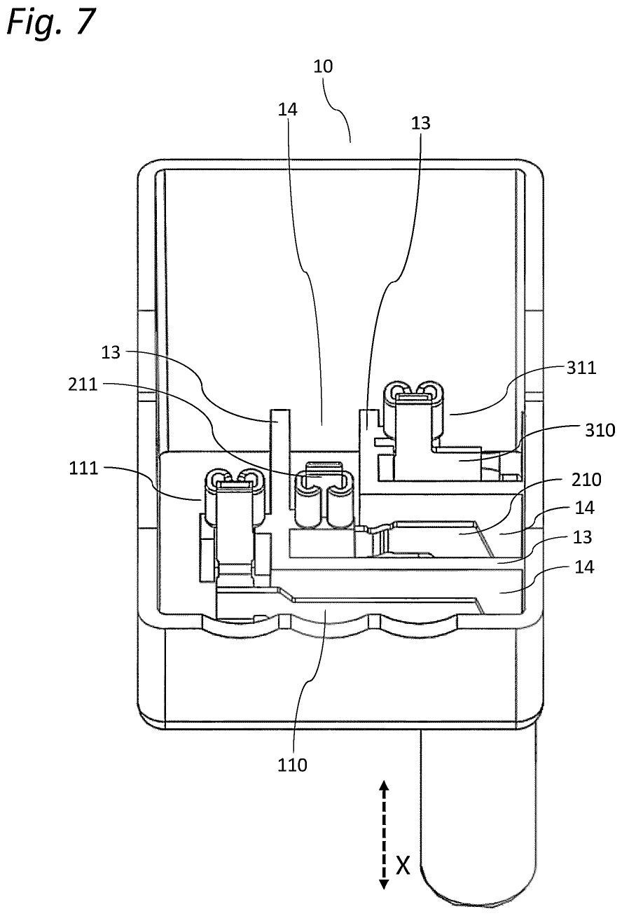

FIG. 7 shows the first housing part 10 from FIG. 6 with the first connection elements 110, 210 and 310 of the respective contact devices 100, 200 and 300 to be formed arranged therein in the course of forming a plug-in connection and preferably a latching connection of the first housing part 10 with the second housing part 20 in the plug-in direction X.

FIG. 8A to 8C show the second housing part 20, which is configured and/or designed to form a plug-in connection with the first housing part 10 in the plug-in direction X. Analogous to the first housing part 10, the second housing part 20 can be produced accordingly as disclosed herein. Corresponding to the openings 11 and 12 of the first housing part 10, the second housing part 20 comprises a first projection 21 and a second projection 22 opposite the first projection 21 (not visible in FIG. 8A to 8C; however, see FIG. 10A). Both the first projection 21 and the second projection 22 have a substantially wedge-shaped outer contour in one view.

The second housing part 20 further comprises three openings for the introduction of electrical conductors in order to contact them with the corresponding second connection element 120, 220 and 320 for the transmission of electrical energy and/or electrical signals (not identified in more detail in FIG. 8A to 8C for reasons of clarity).

It can be seen in particular from FIG. 8B that the respective second connection elements 120, 220 and 320 are arranged and/or fastened in the second housing part 20, of which the coupling portions 121, 122; 221, 222 and 321, 322 are visible.

In the plug-in connector 1 according to the present invention, the contact devices 100, 200 and 300 are thus preferably formed only when the first housing part 10 is plugged together and locked with the second housing part 20 via the respective first and second connection elements 110, 120; 210, 220 and 310, 320.

As already described, the first housing part 10 and the second housing part 20 are plugged together substantially in the plug-in direction X and form corresponding latching connections after the first and second projections 21 and 22 have penetrated at least in portions into the first and second openings 11 and 12. To illustrate this in more detail, FIG. 9A shows in a perspective view an arrangement of the first housing part 10 from FIGS. 5 to 7 and the second housing part 20 from FIG. 8A to 8C in a first state for forming the plug-in connector 1 according to the present invention.

As can be seen from FIG. 9A, the second housing part 20 is not yet in the state of forming a latching connection with the first housing part 10. FIG. 9B shows the arrangement of the housing parts 10 and 20 in a second state, i.e., when a latching connection is formed via the openings 11 and 12 and the projections 21 and 22. In other words, FIG. 9B shows the plug-in connector 1 fully installed.

FIG. 10A is a front view of the not yet fully installed plug-in connector 1 from FIG. 9A.

FIG. 10B is a partial sectional view of the plug-in connector 1 from FIG. 10A (section A-A in FIG. 10A). Clearly visible is the second connection element 120 of the first contact device 100, which has a substantially U-shaped configuration, wherein the coupling portions 121 and 122 serve as legs of the substantially U-shaped configuration, which are substantially flat and substantially plate-shaped. Furthermore, the coupling portion 111 of the first connection element 110 of the first contact device 100 and the coupling portion 311 of the first connection element 310 of the third contact device 300 can be seen from FIG. 10B.

The web region of the second connection element 120 of the first contact device 100 facing away from the legs and thus from the coupling portions 121 and 122 further serves for contacting and/or connecting to an electrical conductor in order to transmit electrical energy and/or electrical signals via the first contact device 100. Analogously, this also applies to the second and third contact devices 200, 300.

By further plugging the first housing part 10 and the second housing part 20 into one another in the plug-in direction X, the coupling portion 121 of the second connection element 120 gradually penetrates into the coupling portion 111 of the first connection element 110, which coupling portion is designed as a flat plug sleeve, in order to form a positive and non-positive connection and thereby to form the first contact device 100 during the installation of the first housing part 10 and the second housing part 20.

The plug-in connector 1 according to the present invention is characterized in that, for example, different components or elements are assigned different functions and thus requirements such as electrical conductivity, stiffness, relaxation behavior, etc., are decoupled from one another with respect to components and elements or can be specifically assigned to individual components or elements.

Furthermore, for example, through the configuration and/or form and thus through the design of the at least one contact device 100, 200, 300, a simplified and thus optimized installation of comparatively complex connection elements can be ensured. The contact devices 100, 200, 300 do not have to be completely produced before integration and installation in the housing of the plug-in connector 1, i.e., mainly assembled, but are formed during the installation of the other components and/or elements, preferably housing parts, so that additional work steps are eliminated. Such connection elements 110, 120; 210, 220; 310, 320 can be constructed relatively small as contact metals of the plug-in connector 1 and can thus be transported relatively easily as bulk goods. Furthermore, due to their design as individual parts, such connection elements 110, 120; 210, 220; 310, 320 can be designed to be relatively robust. As can be seen from the second connection element 120, 220 and 320, the plug-in connector 1 according to the present invention is also characterized, for example, by the use of identical parts. By using individual parts to form the contact devices 100, 200, 300, differently configured contact devices 100, 200, 300 comprising different conductor connection technology can also be realized in the plug-in connector 1 according to the present invention.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Plug-in connector
10 First housing part
11 First opening
12 Second opening
13 Wall/wall portion/intermediate wall
14 Cavity
20 Second housing part
21 First projection
22 Second projection
100 Contact device
110 First connection element
111 Coupling portion
112 Receiving portion
113 Clamping leg
114 Clamping leg
120 Second connection element
121 Coupling portion
122 Coupling portion
200 Contact device
210 First connection element
211 Coupling portion
212 Receiving portion
220 Second connection element
221 Coupling portion
222 Coupling portion
300 Contact device
310 First connection element
311 Coupling portion
312 Receiving portion
320 Second connection element
321 Coupling portion
322 Coupling portion
B1 First sheet
B2 Second sheet
D1 First sheet thickness
D2 Second sheet thickness
X Plug-in direction

1: A plug-in connector, comprising:
at least one contact device configured to transmit electrical energy and/or electrical signals,
the at least one contact device including at least one first connection element comprising a coupling portion and at least one second connection element comprising a coupling portion,
wherein the at least one first connection element and the at least one second connection element each comprise individual parts, and
wherein the coupling portions are configured to contact one another to form the at least one contact device.

2: The plug-in connector of claim 1,
wherein the coupling portion of the at least one first connection element and the coupling portion of the at least one second connection element are configured to form a positive connection with each other at least in portions and/or a non-positive connection with each other at least in portions.

3: The plug-in connector of claim 1,
wherein the coupling portion of the at least one first connection element and the coupling portion of the at least one second connection element are configured to form a plug-in connection and/or a latching connection and/or a press connection.

4: The plug-in connector of claim 1,
wherein the at least one first connection element and the at least one second connection element are each produced from a sheet,
wherein the sheet of the at least one first connection element has a first sheet thickness and the sheet of the at least one second connection element has a second sheet thickness, and
wherein the first sheet thickness and the second sheet thickness are the same or different.

5: The plug-in connector of claim 1,
wherein the at least one first connection element and/or the at least one second connection element is produced from a solid metal material by at least one machining process.

6: The plug-in connector of claim 1,
wherein the at least one first connection element and/or the at least one second connection element is spring-elastic at least in portions.

7: The plug-in connector of claim 1,
wherein the at least one first connection element and the at least one second connection element have a different stiffness and/or a different electrical conductivity and/or a different relaxation constant.

8: The plug-in connector of claim 1,
wherein the at least one first connection element has a receiving portion configured to connect a component,
wherein the coupling portion is arranged at a first free end of the at least one first connection element and the receiving portion is arranged at a second free end of the at least one first connection element, and
wherein the at least one first connection element between the coupling portion and the receiving portion comprises a flat strip.

9: The plug-in connector of claim 7,
wherein the receiving portion has two clamping legs that are spaced apart from one another and/or arranged opposite one another.

10: The plug-in connector of claim 1,
wherein the at least one second connection element is U-shaped and/or bow-shaped and has two coupling portions that are identical to one another and/or spaced apart from one another and/or arranged opposite one another.

11: The plug-in connector of claim 10,
wherein at least one coupling portion is flat and/or plate-shaped.

12: The plug-in connector of claim 1,
further comprising:
at least one second contact device comprising at least one first connection element and at least one second connection element,
wherein the at least one first connection element of the at least one first contact device and the at least one first connection element of the at least one second contact device are identical to one another at least in portions, and/or
wherein the at least one second connection element of the at least one first contact device and the at least one second connection element of the at least one second contact device are identical to one another.

13: The plug-in connector of claim 1,
wherein the at least one first connection element and/or the at least one second connection element is produced at least in portions by at least one punching process and/or at least one bending process, and/or is in each case formed integrally in one piece.

14: The plug-in connector of claim 1,
wherein the plug-in connector has a first housing part and a second housing part to form a plug-in connection in a plug-in direction, and
wherein the at least one first connection element is arranged in the first housing part and the at least one second connection element is arranged in the second housing part.

15: The plug-in connector of claim 14,
wherein the at least one first connection element is arranged in the first housing part and the at least one second connection element is arranged in the second housing part such that the at least one contact device is formed when the plug-in connection is formed.

16: The plug-in connector of claim 1, wherein the plug-in connector is configured to connect at least one electrical conductor, a mating connector, and/or a base strip to the at least one contact device.

17: The plug-in connector of claim 1, wherein the coupling portions are configured to contact one another variably in a plug-in direction to form the at least one contact device.

18: The plug-in connector of claim 4, wherein the at least one first connection element and the at least one second connection element are each produced from a flat sheet or thin sheet.

19: The plug-in connector of claim 8, wherein the flat strip is angled in portions.

20: The plug-in connector of claim 9, wherein the two clamping legs are symmetrical and/or fork-shaped with respect to a plane in order to contact the component in a clamping manner.
